(19) United States
(12) Patent Application Publication
(10) Pub. No.: US 2013/0085816 A1
(43) Pub. Date: Apr. 4, 2013

(54) ONLINE COMMUNITIES FOR FINANCIAL SERVICES PRODUCTS

(71) Applicants: Paul WILMORE, Fort Washington, PA (US); Jared YOUNG, Media, PA (US); Glenn C. McMILLEN, Downingtown, PA (US)

(72) Inventors: Paul WILMORE, Fort Washington, PA (US); Jared YOUNG, Media, PA (US); Glenn C. McMILLEN, Downingtown, PA (US)

(73) Assignee: Barclays Bank Delaware, Wilmington, DE (US)

(21) Appl. No.: 13/608,743

(22) Filed: Sep. 10, 2012

Related U.S. Application Data
(60) Provisional application No. 61/532,960, filed on Sep. 9, 2011.
(60) Provisional application No. 61/588,400, filed on Jan. 19, 2012.

(51) Int. Cl. G06Q 50/00

(52) U.S. Cl. CPC G06Q 50/01
USPC 705/12; 705/319; 705/35; 705/39; 705/14.16

(57) ABSTRACT

An online community for users of a financial services product, such as credit card users, and various features of such communities. For example, the members can share profits based on community performance, provide feedback and vote on ways to improve the financial services product experience, and help one other when possible. The online community can provide status indicators corresponding to members' engagement within the online community, publish the profit and loss statement of the financial services product associated with the community, provide a decline process that facilitates approval to the community for customers with improving credit, link members' deposits to provide a higher interest rate, automatically transfer balances between banks, and pay referral fees to the community.

### CROSS REFERENCE TO RELATED APPLICATIONS

This application claims the benefit of U.S. Provisional Patent Application No. 61/532,960, filed Sep. 9, 2011, and U.S. Provisional Patent Application No. 61/588,400, filed Jan. 19, 2012, the entireties of which are incorporated herein by reference.

### FIELD OF THE DISCLOSURE

This relates to online communities, including creating and managing online communities for users of financial services products such as credit cards.

### BACKGROUND

Several challenges exist for issuers (e.g., banks) of financial services products (e.g., credit cards) in acquiring and retaining customers. For example, customers become dissatisfied with banks due to a lack of transparency with respect to credit card products and due to a lack of sufficient engagement in their credit card product options. This results in customers not remaining loyal to banks, increasing the costs for banks to acquire and retain customers.

### SUMMARY

An online community for users of a financial services product is disclosed. The system can restrict membership of the online community to users of the financial services product and allow social interaction via the online community between any members of the membership. By integrating a social media platform with a financial services product, the online community can change the way financial services products are created and managed by issuers and used by customers.

For example, the members can share profits based on community performance, provide feedback and vote on ways to improve the financial services product experience, and help one other when possible. The online community can provide status indicators corresponding to members' engagement within the online community, publish the profit and loss statement of the financial services product associated with the community, provide a decline process that facilitates approval to the community for customers with improving credit, link members' deposits to provide a higher interest rate, automatically transfer balances between banks, and pay referral fees to the community.

### BRIEF DESCRIPTION OF THE DRAWINGS

FIG. 1 illustrates an example of an online community system architecture.

FIG. 2 illustrates an example of an online community member network.

FIGS. 3-11 illustrate examples of community reputation system components.

FIGS. 12-18 illustrate examples of community P&L system components.

FIG. 19 illustrates an example of declined applicant improving credit evaluation system components.

FIG. 20 illustrates an example of community deposits system components.

FIG. 21 illustrates an example of community share management system components.

FIGS. 22-23 illustrate examples of recurring balance transfer system components.

FIG. 24 illustrates an example of community referral marketing system components.

FIG. 25 is a block diagram of an example of a computing device.

### DETAILED DESCRIPTION

The present disclosure is directed to online communities for users of financial services products such as credit cards. Although the embodiments disclosed herein describe individual online communities created and managed around the use of particular financial services product, the online communities are not so limited and can also be created and managed around the use of any suitable product or service, such as deposit products, in accordance with the teachings of the present disclosure.

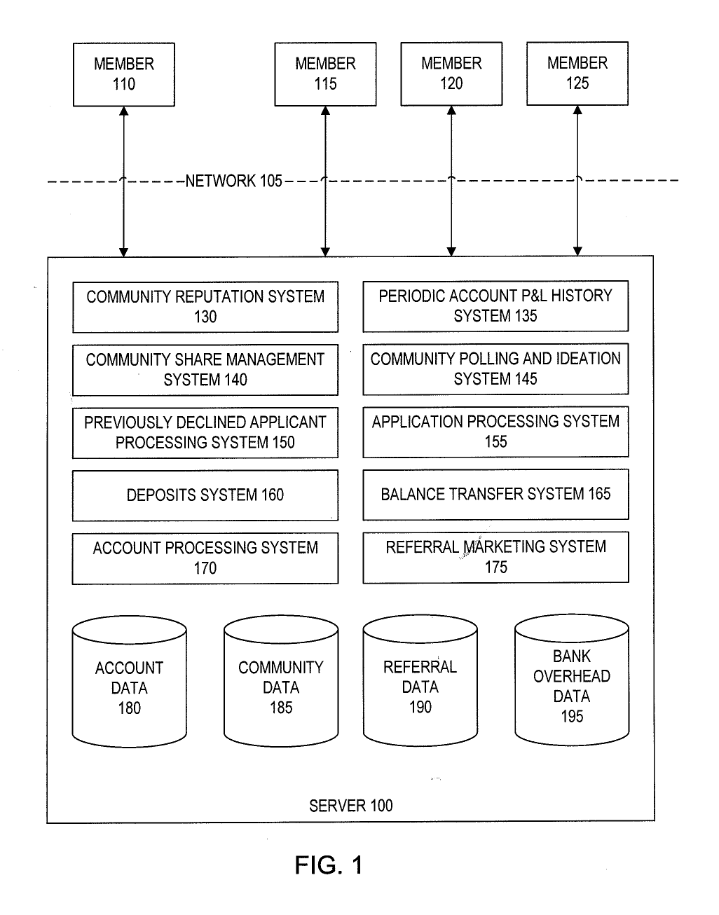

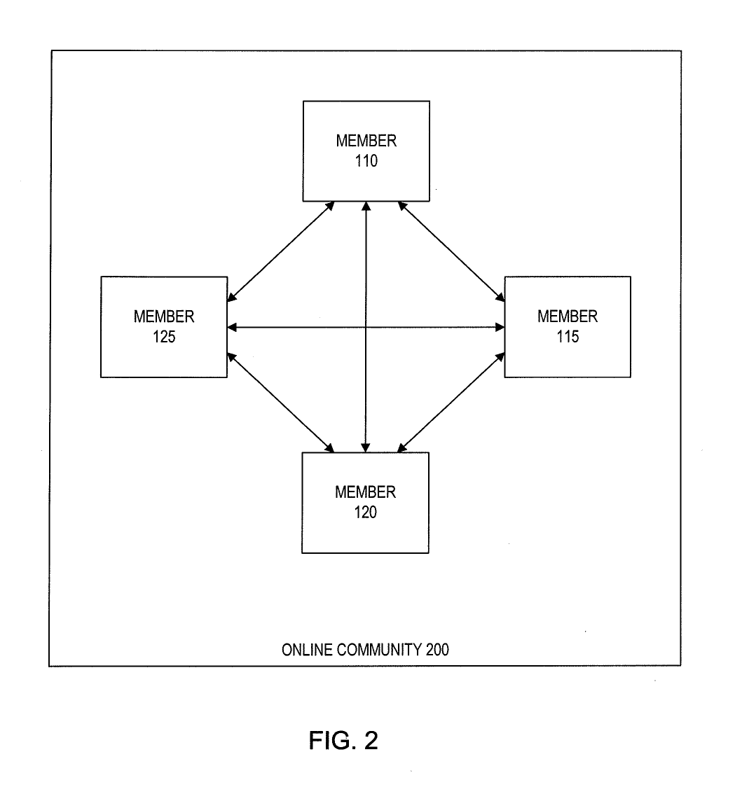

FIGS. 1 and 2 illustrate an example of an online community system architecture and member network. In the illustrated embodiment, server 100 can comprise one or more servers deploying online community 200, which can comprise a web site or other virtual environment or online platform accessible via network 105. Server 100 can be coupled with system components such as community reputation system 130, periodic account P&L history system 135, community share management system 140, community polling and ideation system 145, previously declined applicant processing system 150, application processing system 155, deposits system 160, balance transfer system 165, account processing system 170 and referral marketing system 175. Server 100 can be coupled with data components such as account data 180, community data 185, referral data 190 and bank overhead data 195.

Server 100 is accessible via network 105 to one or more client devices, such as, for example, member 110, member 115, member 120 and member 125, each of which can be operated by a respective member of online community 200 (hereinafter referred to as “the system”). The system can restrict membership of online community 200 to users of a financial services product such as a credit card by, for example, requiring each user to be an accountholder with the financial services product and have an identifiable account associated therewith in account data 180 in order to gain membership. The system can also allow social interaction via online community 200 between any members of the membership as shown by the arrows in FIG. 2.

The system can provide a reputation management system for online community 200. In order to build loyalty within the financial services product, the system can track customer engagement within the online community across a number of areas and feed back an overall community status level. For example, customers/members can improve their status in different ways such as by helping community members in forums of online community 200, providing feedback on the product to each other as well as to the financial service provider, referring customers to online community 200, and using the product by spending on the account or revolving balances. As customers increase their engagement across the above areas, they can receive from the system a particular score, which can translate into a particular status level which in turn can enable certain features to be available to them. Any suitable feature or combination of features can be provided to higher status customers, including, for example, greater profit share amounts and increased voting privileges to drive change within the community as described below.

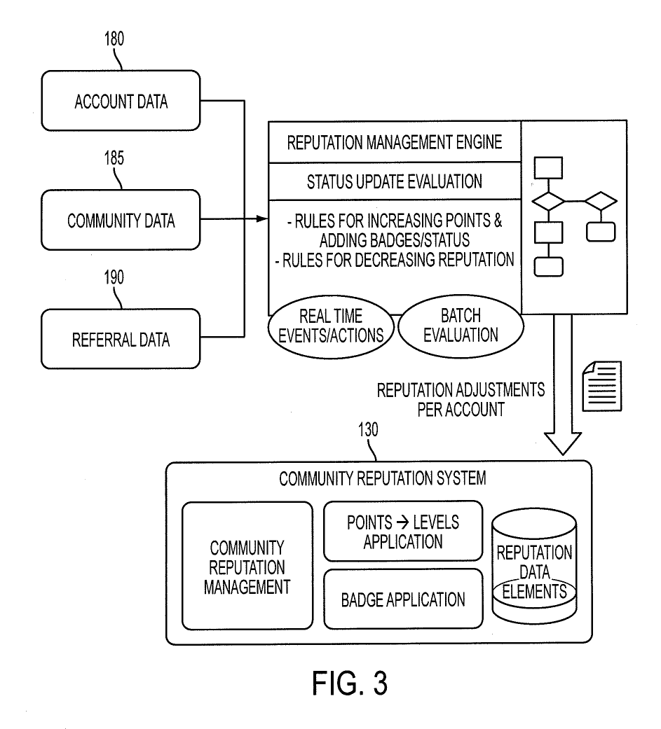

FIGS. 3-11 illustrate examples of community reputation system components of online community 200. As shown in FIG. 3, community reputation system 130 performs community reputation management by applying points and levels as well as badges to members and storing reputation data elements for the members. For example, community reputation system 130 can receive reputation adjustments per account from a status update evaluation process by a reputation management engine. The reputation management engine can apply rules for increasing points and adding badges/status and apply rules for decreasing reputation based on data provided by account data 180, community data 185 and referral data 190. These rules can be applied based on real time events/actions and also in a batch evaluation.

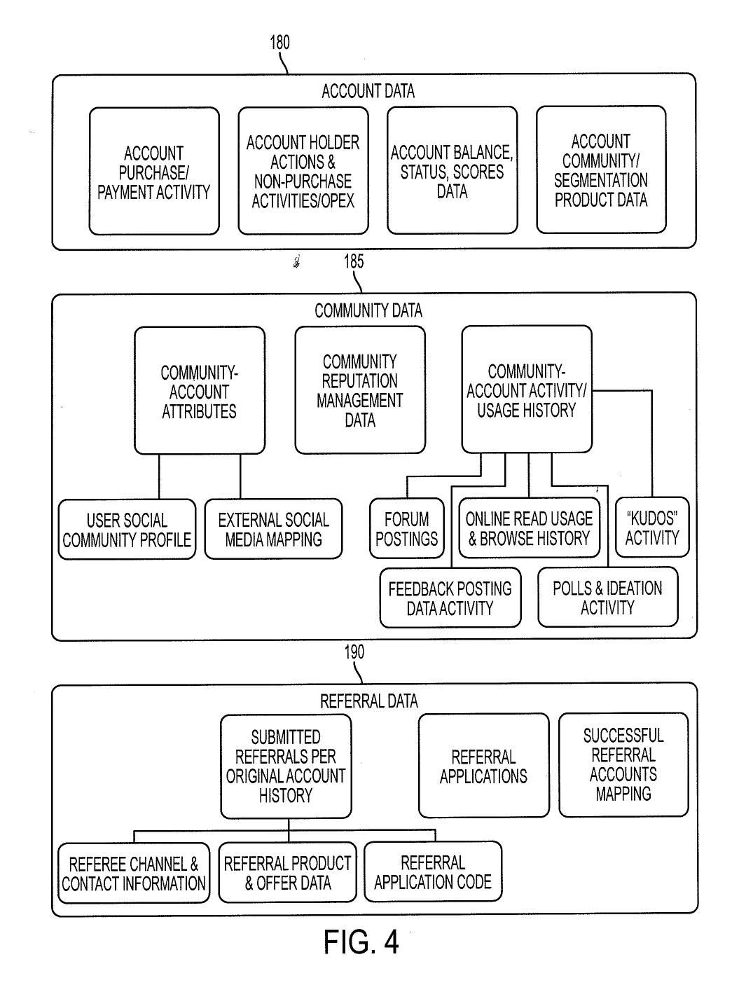

FIG. 4 shows examples of account data 180, community data 185 and referral data 190. In particular, account data 180 can comprise, for example, account purchase/payment activity; account holder actions and non-purchase activities/operating expenses; account balances, status, and scores data; and account community/segmentation/product data. Community data 185 can comprise, for example, community-account attributes, such as user social community profiles and external social media mapping (e.g., to external social networking sites such as Facebook, Twitter, etc.); community reputation management data; and community-account activity/usage history, such as forum postings, online read usage and browse history, “Kudos” activity, feedback posting data activity and polls and ideation activity. Referral data 190 can comprise, for example, submitted referrals per original account history such as referee channel and contact information, referral product and offer data and referral application code; referral applications; and successful referral accounts mapping.

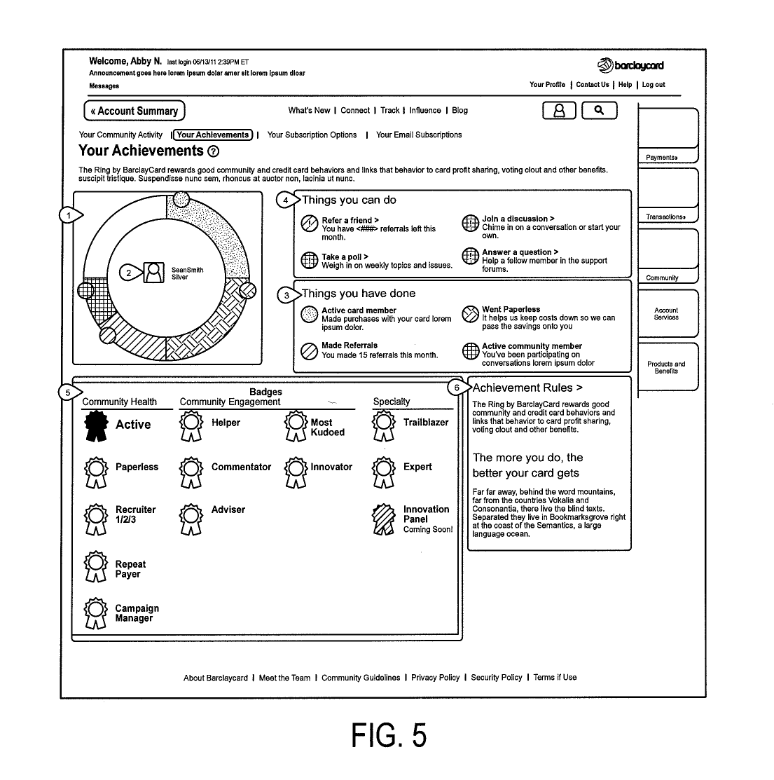

FIG. 5 shows an example of achievements that can be earned by and rendered to members of online community 200. In the illustrated embodiment, the “Achievements” section of the web page is meant to display all the “activity” a user has completed or can complete, all in one place. Achievements can comprise a member's reputation within the community and be established visually such as in three ways: in a status indicator, with a rank and with badges. The status indicator of the illustrated embodiment takes the form of a ring, but it may comprise any suitable shape or form.

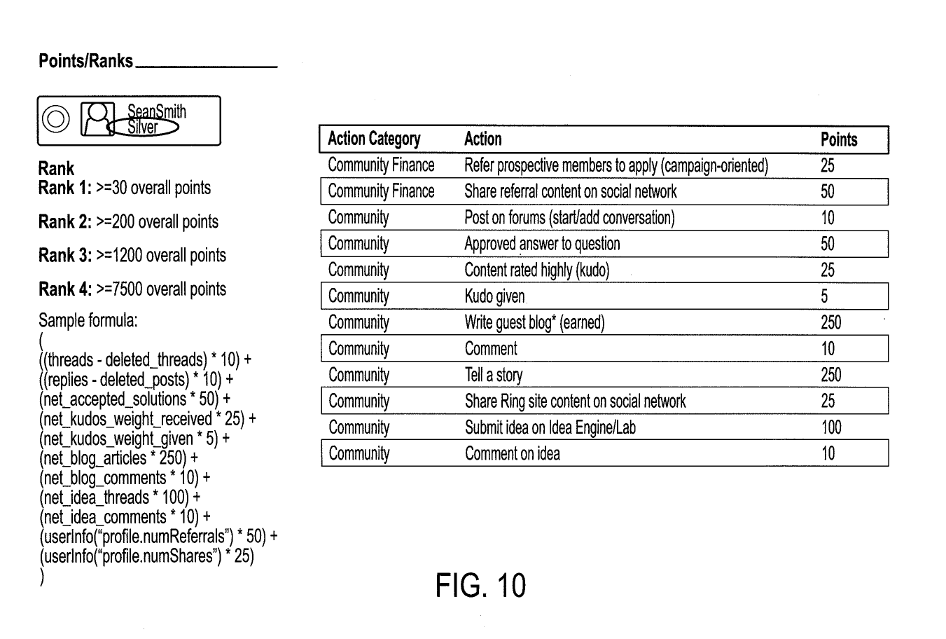

Certain activities can merit badges. Some badges can have levels and every member can see another member's full list of badges. Points can be based on community, purchasing and servicing activities (see, e.g., points table in FIG. 10). The system can be configured to disallow any member from seeing points. Ranks can be based on points. A rank can reflect a range of points and be achieved after reaching a threshold (see, e.g., points table in FIG. 10). The system can be configured to allow all members to see another member's rank. The status indicator (ring) can reflect, for example, a member's latest monthly activity and its community segment (explained below) can be based on points. The system can be configured to allow all members to see another member's status indicator.

The status indicator can comprise multiple segments, each of the segments corresponding to a distinct type of activity associated with the respective member of online community 200. The distinct type of activity can comprise any suitable activity, such as an amount of financial account activity associated with the respective member (e.g., being an active card member as described below) and/or an amount of activity undertaken by the respective member in online community 200 (e.g., going paperless, making referrals and community activity as described below).

For one or more of the segments, a size of the respective segment can change based on an amount of the distinct type of activity corresponding to the respective segment that is associated with the respective member of the online community. The multiple segments can form a partial or complete geometric shape, such as a ring or rectangle, or any other suitable pictorial representation.

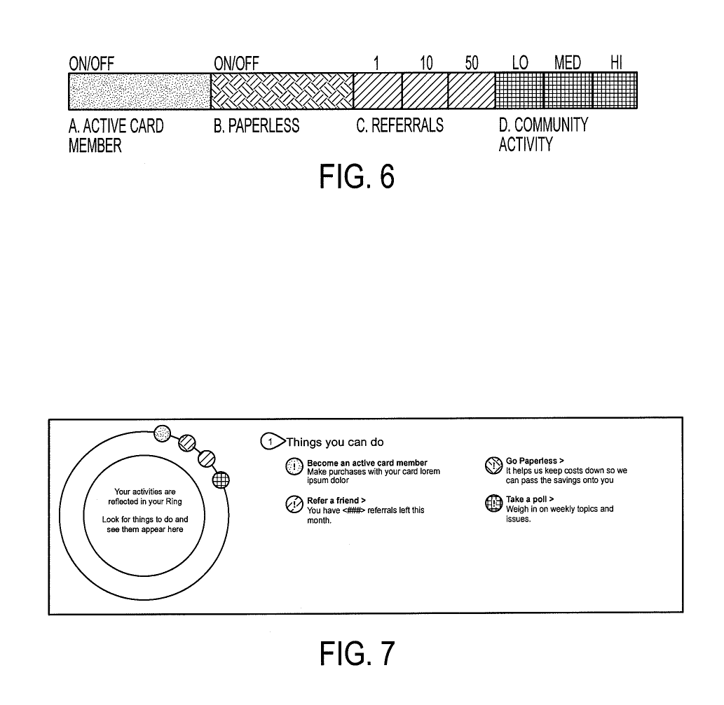

For example, annotation “1” (denoted by the numeral “1” within a sideways oriented teardrop in FIG. 5) identifies a ring status indicator, which can be divided into 4 segments, each with the ability to fill in ¼ of the ring, each with a corresponding color/pattern and icon as shown in FIGS. 5 and 6 and as described below in connection with FIG. 6:

a. Active Card Member: Fills in if the user has a statement balance greater than zero in the last six months, having a current balance greater than zero or having an activity on their account within the last 6 months. If so, that ¼ of the ring (the entire segment) becomes fully filled.

b. Paperless: Fills in if the user has gone paperless. If so, that ¼ of the ring (the entire segment) becomes fully filled.

c. Referrals: Based on the amount of referrals the user has sent out. Has 3 levels, each filling in 1/12 of the ring (⅓ of the segment): 1 referral, 10 referrals, 50 referrals

d. Community Activity: Based on how many kudos and posts the user contributed with in the community within the last 30 days. Has 3 levels, each filling in 1/12 of the ring (⅓ of the segment):

Low: >=40 community category points in the past 30 days (community finance points not included)

Medium: >=520 community category points in the past 30 days (community finance points not included)

High: >=1746 community category points in the past 30 days (community finance points not included)

The following provides a sample formula for the point calculation:

$$( ( ( threads - deleted\_threads ) * 10 ) + ( ( replies - deleted\_posts ) * 10 ) + ( net\_accepted \_solutions * 50 ) + ( net\_kudos \_weight \_received * 25 ) + ( net\_kudos \_weight \_given * 5 ) + ( net\_blog \_articles * 250 ) + ( net\_blog \_comments * 10 ) + ( net\_idea \_threads * 100 ) + ( net\_idea \_comments * 10 ) )$$

FIGS. 7-9 illustrate a manner in which the ring can change depending on status. FIG. 7 shows a representation of the ring when no actions have been taken by a member. Since no actions have been performed by the user yet, the user has an empty ring and no badges. As reflected by annotation “1” in FIG. 7, “Things you can do” is the only portion that appears; “Things you have done” does not appear.

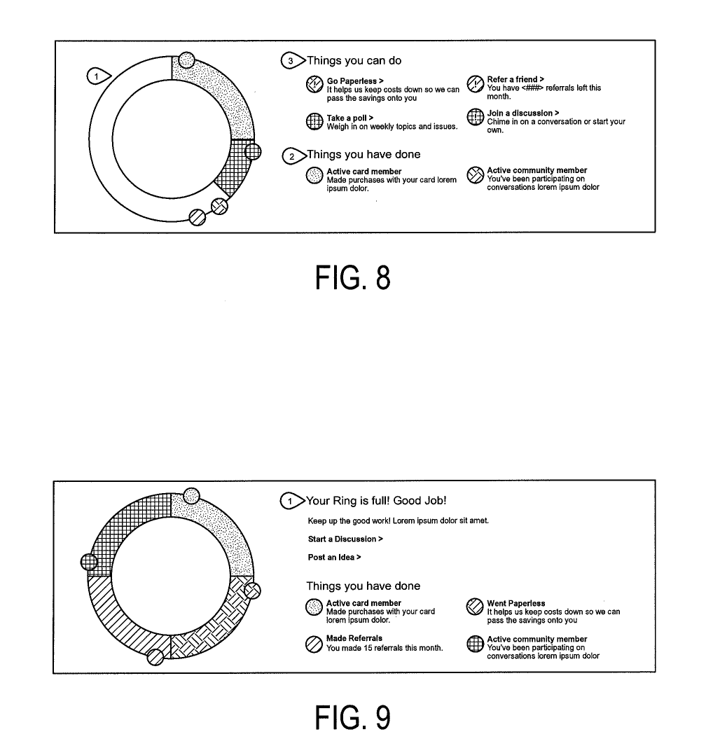

FIG. 8 shows a representation of the ring when some actions have been performed by the user, which impacts the user's ring. As reflected by annotation “1” in FIG. 8 identifying the ring, some segments have been partially or fully filled. Segments that have not been filled can display an icon within the empty area. The filled section can appears in order (active member, paperless, referrals, community activity), and the unfilled activity can display icons for completely unfulfilled segments in the same order. As reflected by annotation “2” in FIG. 8 identifying the “Things You Have Done” section, only 2 items appear here corresponding to segments that are partially or fully fulfilled based on the user's activity. As reflected by annotation “3” in FIG. 8 identifying the “Things you can do” section, up to 4 actions appear here.

FIG. 9 shows a representation of the ring when the user has accomplished enough actions to fulfill the ring. As reflected by annotation “1” in FIG. 9, the “Things you can do” panel does not appear; instead, a message about the ring being full, and call-outs to keep up the good work by participating in the community can be presented. Links can take the user to a Discussions Home Page and a Submit an Idea page.

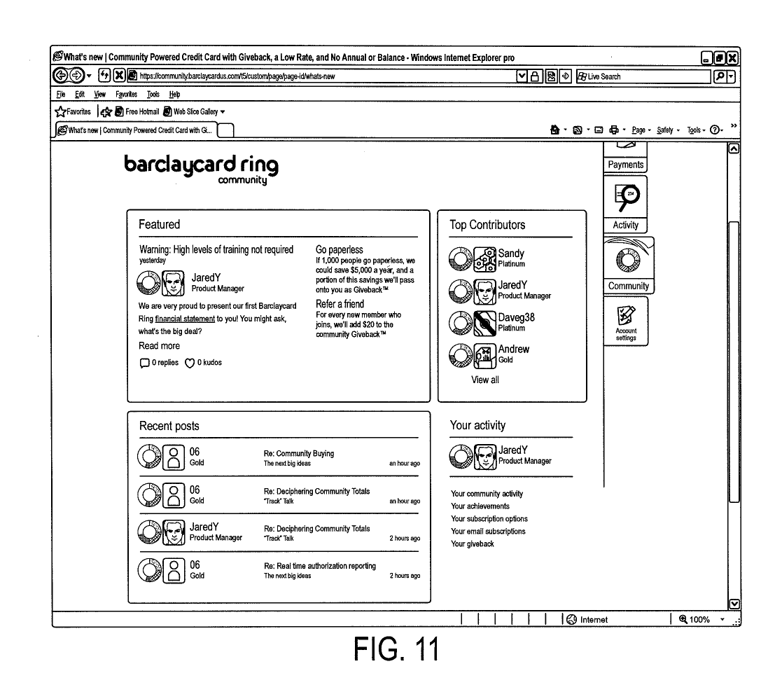

FIG. 11 shows a community page within online community 200. In this page, the system dynamically displays the status indicators such that the status indicators reflect real-time status levels associated with each user rendered on the page, such as with respect to the four top contributors shown on the upper right portion of the page and the four recent posters shown on the lower left portion of the page. The system can also render a member's status level on multiple pages that the member navigates within online community 200 so that the member can be continually apprised of their community status.

Returning to FIG. 5, annotation “2” (denoted by the numeral “2” within a sideways oriented teardrop in FIG. 5) identifies a user mini profile, which can display the user's display name, picture and their rank. Ranks can be calculated summing up all the points the user has accumulated over time (see Points table in FIG. 10).

Annotation “3” (denoted by the numeral “3” within a sideways oriented teardrop in FIG. 5) identifies a “Things You Have Done” section. This section can display a note for each of the ring segments that has been filled because of user activity by the user. These items can be configured not to link anywhere. Notes can appear in the following order: a. Active Card Member, b. Paperless, c. Make a Referral, d. Community Activity (a different note can appear for low, medium and high levels).

Annotation “4” (denoted by the numeral “4” within a sideways oriented teardrop in FIG. 5) identifies a “Things You Can Do” section. This section can be displayed based on ring segments not being completely filled, and can display up to 4 suggested actions that the user has not performed yet, in the following order:

a. Active Card Member

b. Go Paperless: Links to Account Services: Enroll in Paperless Statements on the Servicing Site. Appears if the user is not marked as being paperless.

c. Refer a Friend: Links to open the Referral overlay. This link does not appear if Refer a Friend has been turned off for the community or for the logged in user.

d. Community Activity:
Join a Discussion: Links to Discussion home page. Appears if the user has not started or post 6 times in discussion threads in the past 30 days.
Kudo Something: Links to Discussion home page. Appears if the user has not kudoed anything on the site up to 5 times.
Answer a Question: Links to the “Ask & Answer” Home Page. Appears if the user has not answered 2 questions that got accepted in the past 30 days.
Submit an Idea: Links to the Submit an Idea page. Appears if the user has not posted 1 idea to the Ideas section in the past 30 days.

Annotation “5” (denoted by the numeral “5” within a sideways oriented teardrop in FIG. 5) identifies a badge List. Badges can be earned based on the member's activity. For certain activities members can achieve badges. Some badges can have multiple levels. All the badges can be available and once a member achieves a badge, the Badge can change state to reflect such. If the user clicks on the badge, a “Full Badge Description” page can appear.

Examples of badges can include:

“Personal Finance” badges:
“Active”: set if the customer has a statement balance greater than zero in the last six months, having a current balance greater than zero or having an activity on their account within the last 6 months

“Community Finance” badges:
“Paperless”: sign up for e-statement or online pay
“Recruiter”: refer prospective members to apply, having levels: 1) 1 completed referral, 2) 10 completed referrals, 3) 50 completed referrals
“Campaign Manager”: refer on two external social networks; “Repeat Payer”)

“Community Engagement” badges:
“Helper”: answered 20 questions in the Help section
“Adviser”: 5 approved answers on the Ask & Answer section (does not include discussion boards, blog comments or ideas) and 10+ kudos received on any discussion board post or Ask & Answer post (does not include blog comments or ideas)
“Commentator”: commented 25+ times on blog posts or idea threads
“Innovator”: post five ideas with 7+ kudos each
“Most Kudoed”: received Kudos, having Levels: 1) 5 Kudos 2) 15 Kudos 3) 30 Kudos))

“Specialty & Super” badges:
“Trailblazer” (permanent badge granted manually): participated on the Alpha community previously
“Expert” (granted manually): community influencer, designation for advocacy for specific activity participation; 0.0X % increase in Profit Share
“Innovation Panel” (granted manually): special engagement opportunity afforded to advocates

Annotation “6” (denoted by the numeral “6” within a sideways oriented teardrop in FIG. 5) identifies manual call-outs. These can comprise links about how the achievements system works, and a proposition statement about how achievements can reflect the health of the community. This link can take members to a Help/P2P section.

Online communities according to the present disclosure are not limited to the points, levels, values, thresholds, names and other specific parameters disclosed in this particular embodiment, but rather can modify or adjust these parameters as appropriate in accordance with the teachings of the present disclosure.

The system can further provide a process whereby the profit and loss statement of the financial services product associated with the community is published in online community 200. In order to build loyalty among customers that are dissatisfied with banks because they are not transparent, the system can publish the P&L of the community periodically (e.g., monthly) in online community 200. There can be explanations of how each line item is calculated to better inform the community. To the extent the P&L is underperforming, the system can explain what improvements will drive better performance, such as by identifying one or more expenses variably based on behavior of the membership and identifying an extent to which the membership behavior can reduce the one or more expenses. In addition, the P&L can accumulate a profit share projection so that community members can anticipate what monies may be returned to the community.

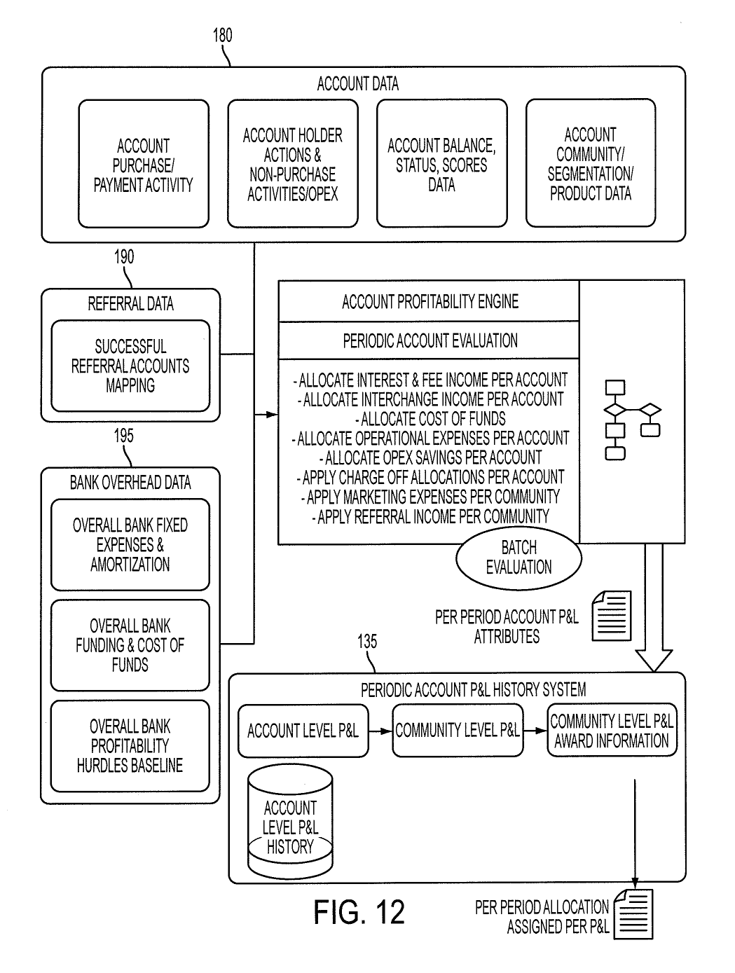

FIGS. 12-18 illustrate examples of community P&L system components of online community 200. As shown in FIG. 12, periodic account P&L history system 135 receives per period account P&L attributes from a periodic account evaluation process by an account profitability engine, and determines a per period allocation assigned per the P&L based on an analysis of an account level P&L, community level P&L, community level P&L award information and account level P&L history.

The periodic account evaluation process can be based on account data 180, referral data 190 and bank overhead data 195, and comprise, in a batch evaluation for example, allocating interest and fee income per account, interchange income per account, cost of funds, operational expenses per account and operating expense savings per account, and applying charge off allocations per account, marketing expenses per community and referral income per community. Account data 180 can comprise, for example, account purchase/payment activity; account holder actions and non-purchase activities/operating expenses; account balances, status, and scores data; and account community/segmentation/product data; referral data 190 can comprise, for example, successful referral accounts mapping; and bank overhead data 195 can comprise, for example, overall bank fixed expenses and amortization, overall bank funding and cost of funds, and overall bank profitability hurdles baseline.

In an effort to simplify the calculations and remove some of the noise, the system can perform the following calculations for four of the P&L line items (cost of funds, interchange, impairment and operating expenses). Other P&L line items (interest, fees, gross losses, VAS) can be shown on a billed basis.

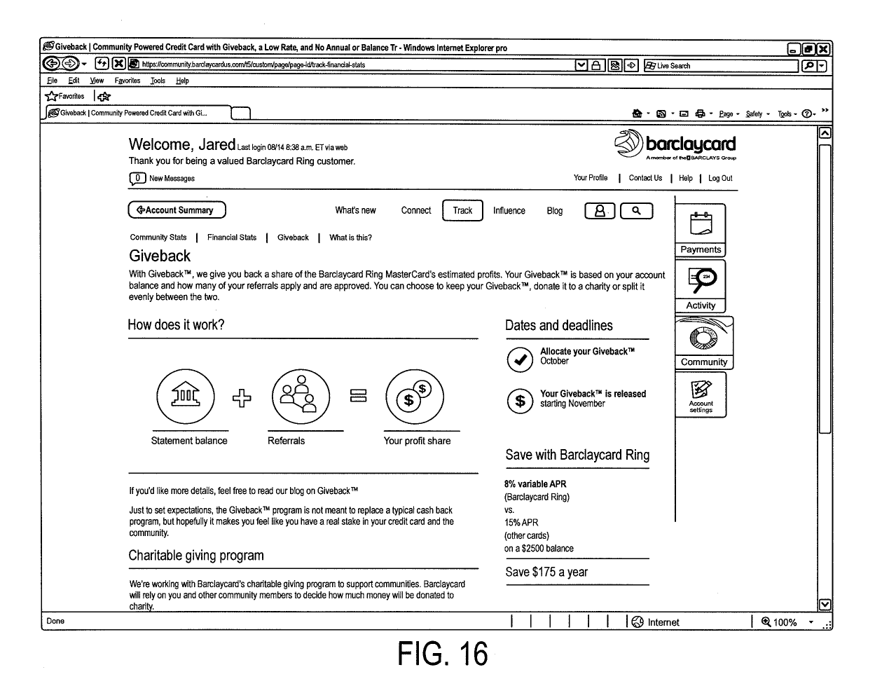

For the cost of funds calculation, cost of funds can be anchored to the Prime rate and start off being P-1.25%, for example. This factor can be updated periodically, such as every Giveback™ period (e.g., 6 months). FIG. 16 shows an example of a display by the system of an explanation for how the Giveback™ program can work, such as calculating a member's particular share of the profits generated by the financial services product based on a combination of account balance and how many of the member's referrals applied and were approved.

For the interchange calculation, interchange can be shown as actual net interchange minus fraud expense but can exclude association bonuses.

For the impairment calculation, loan loss reserves can be estimated by multiplying 3×60+ late balances (estimate of 12 months of future losses). The scalar can be adjusted as the portfolio matures and a specific scalar is identified.

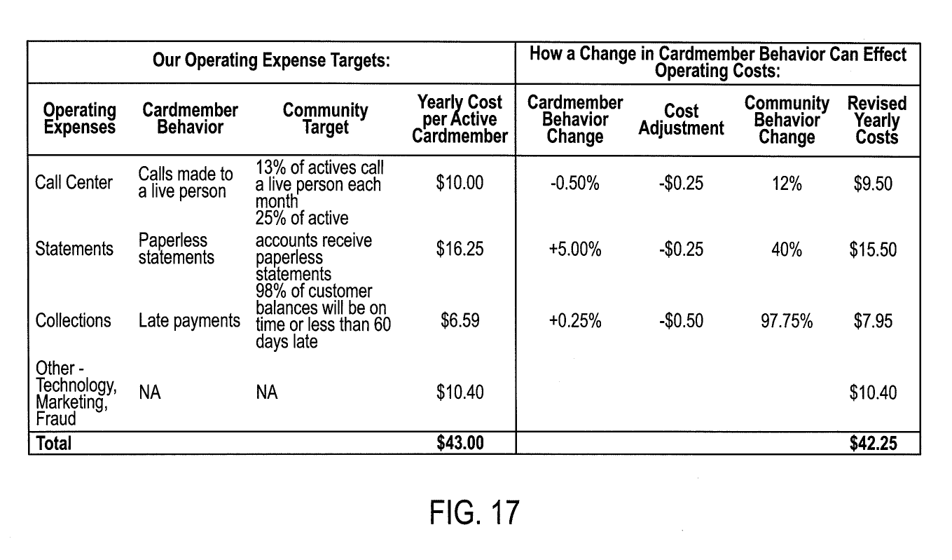

For the operating expenses calculation, operating expenses can be broken into four categories (collections, statements, customer service and other). Members can lower operating expenses by exhibiting certain behaviors, such as paying on time, going paperless and calling less. The system can display a table similar to the table shown in FIG. 17 along with an explanation similar to the following to explain to customers how the calculation will work:
There are numerous expenses we incur to make your credit card life as easy as possible. To keep it simple we are summarizing them into four parts; Statements, Call Center, Collections and Other (I know, the dreaded “other”, not exactly what you wanted to read).
Statements—All of your transactions and all of your account history are stored for us by a company named TSYS. A big portion of TSYS's charges to us is the cost of postage for sending out a monthly statement. You can reduce this expense for the community by $5 per year if you receive paperless statements. You can also sign up for account alerts that make it easier to pay your bill on time. Accounts alerts are automatic emails that let you know your statement is ready or your payment is due. Our costs already assume that 25% of you will sign up for paperless statements, so the savings for the community begin when you collectively exceed that number.
Call Center—A call that is handled by a live agent in the United States costs us over $4. A call to an agent that is not in the United States costs roughly two-thirds that amount. For Barclaycard Ring, most of your live calls are being handled by United States employees. If you only use our automated system to resolve your needs then the cost is even less. To calculate this expense we add up all of the costs for all of the phone minutes the community accrues over the course of the month and you can see the number on the financial stats page.
Collections—When balances are past due you may receive a call or email from us. These are generally expensive and sometimes time consuming calls. Each person that goes 60+ days late costs us over $200 in expenses. For all of the customers that are 60+ days late and we have to add those expenses to the Operating Expenses.
Other—Our technology and marketing teams are constantly working behind the scenes to create a better experience for you with Barclaycard Ring. This cost also includes the work Jen H. is doing as community manager. We apply the cost of their efforts in this portion of the P&L using a per active cardmember amount of $10.43 per month. If you combine all the other expenses, we expect to spend about $43 per month, per active cardmember to provide basic services. You can lower this number by using the website to answer questions, go paperless, and pay on time. Every time you do one of these activities we will lower the expenses loaded into the community P&L!
In the table below, everything to the left of the line shows the community goals for monthly active cardmember costs. It also illustrates how we calculate your operating expenses each month. To the right of the line you can see how a change in community behavior can impact the costs.

For example, referring to the call center operating expense entry from the table shown in FIG. 17, for each 50 basis point improvement in calls not being made to a live person (i.e., for each 0.5% of the membership who stops calling a live person), the operating expense rate can be reduced by $0.25. Thus, if 1% (or 100 basis points) of the membership stops calling the call center (i.e., from 13% to 12% of the membership), then the yearly cost per active cardmember can be reduced by $0.50 (from $10 per active to $9.50).

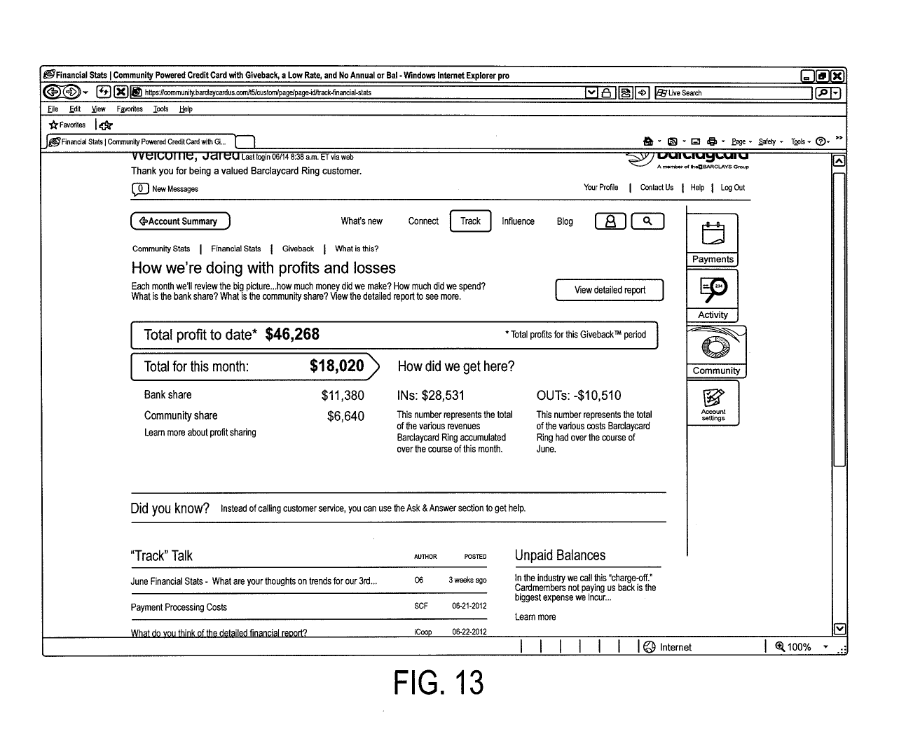

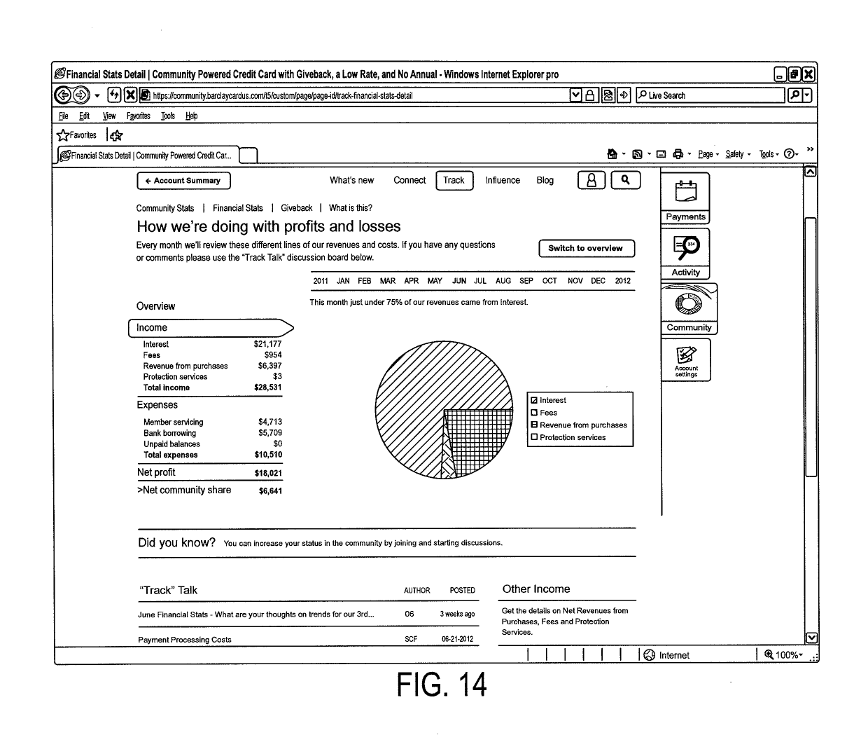

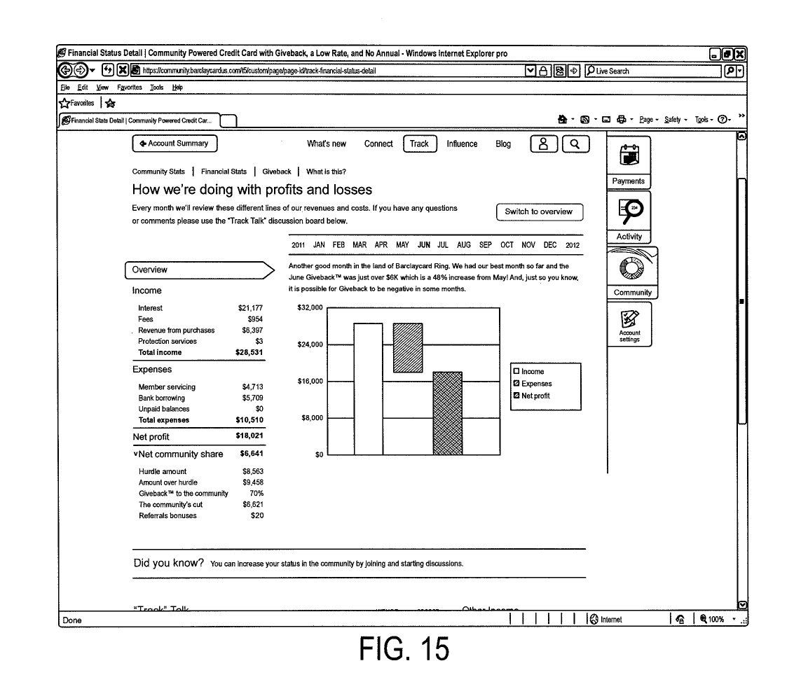

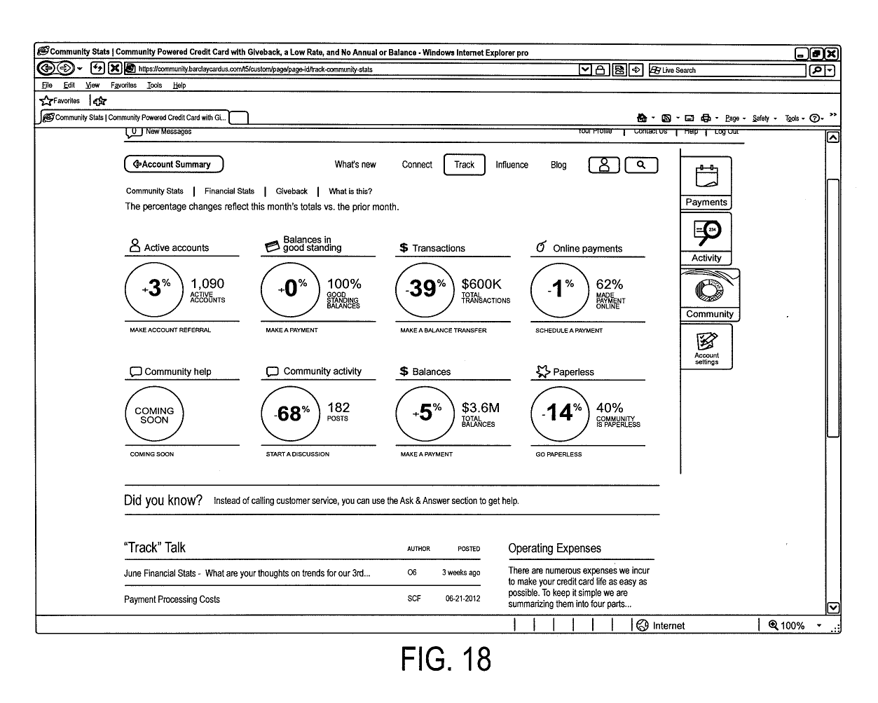

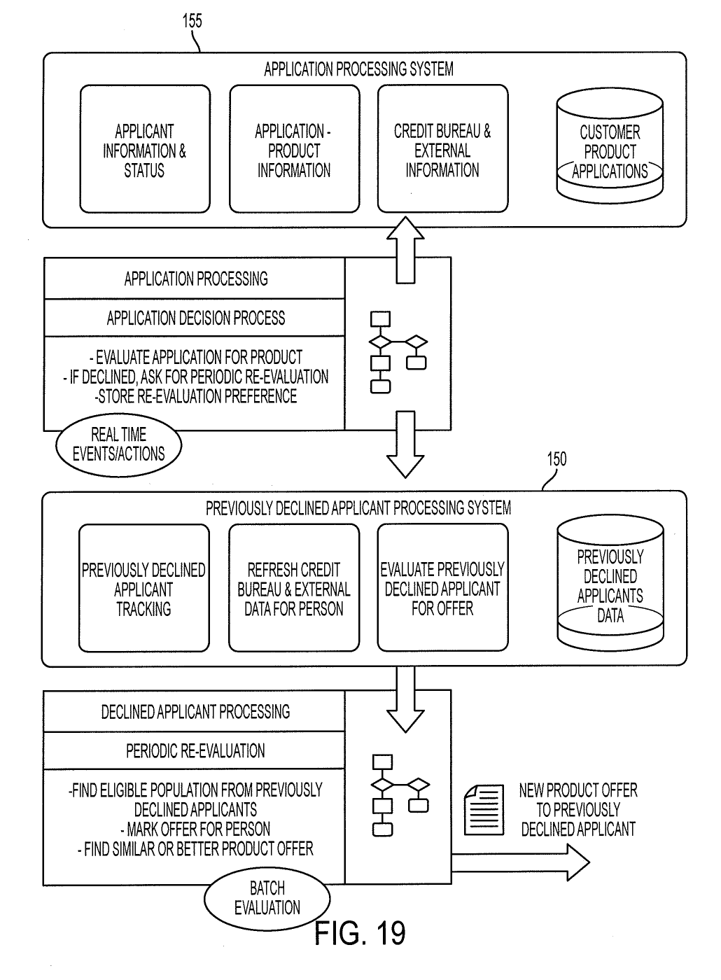

FIG. 13 shows an example of a display of financial statistics for online community 200 comprising a monthly profit value derived by subtracting a published revenue value minus a published expense value, the allocation of the monthly profit between the bank and the community, and the running total of the community's share of the profits for the current Giveback™ period. Additional details of the financial statistics can be published by the system as shown in FIGS. 14 and 15, which show additional income items (e.g., interest, fees, revenue from purchases, protection services) and expense items (e.g., member servicing, bank borrowing, unpaid balances). FIG. 18 shows an example of a display by the system of percentage changes reflecting a current month's totals of community behavior vs. the prior month.

Online communities according to the present disclosure are not limited to the metrics, values, scalars and other specific parameters disclosed in this particular embodiment, but rather can modify or adjust these parameters as appropriate in accordance with the teachings of the present disclosure.

The system can further provide a decline process that facilitates approval to online community 200 for customers with improving credit, since application for credit and to the community can be a moment in time decision and customers with marginal but improving credit thus may have difficulty obtaining credit. Therefore, for a segmented portion of the customers who apply for a product but are declined, the system can asked them if they would like their application saved for a period of time. After a period of time (e.g., 6 months) their file can be prescreened to look for any improvements in their credit profile. If they are approved, they can be invited to join the community. The application can be pre-populated with elements from the prior application and if the same, the customer can quickly be approved for the product.

FIG. 19 illustrates an example of declined applicant improving credit evaluation system components of online community 200. As shown in FIG. 19, previously declined applicant processing system 150 uses previously declined applicants' data to perform previously declined applicant tracking, refresh credit bureau and external data for a previously declined applicant, and evaluate the previously declined applicant for an offer to join the community.

Previously declined applicant processing system 150 can operate in coordination with applicant processing system 150, which initially evaluates an applicant for the financial services product during application processing by an application decision process based on a customer product application and applicant information and status, application—product information, credit bureau and external information. If the applicant is declined, applicant processing system 150 can ask the applicant whether a periodic reevaluation is desired and stores the resulting reevaluation preference. This can be performed based on real time events/actions.

Based on a periodic reevaluation during declined applicant processing, previously declined applicant processing system 150 can determine an eligible population from previously declined applicants based on at least the stored reevaluation preferences and improved credit and mark an offer for the person and/or find a similar or better product offer, which can then be provided to the previously declined applicant. This can be performed based on a batch evaluation.

The system can further link members' deposits to provide a higher interest rate. This can be based on the standard deposits feature of tiered interest, such that the higher the balance in the account the higher the interest rate.

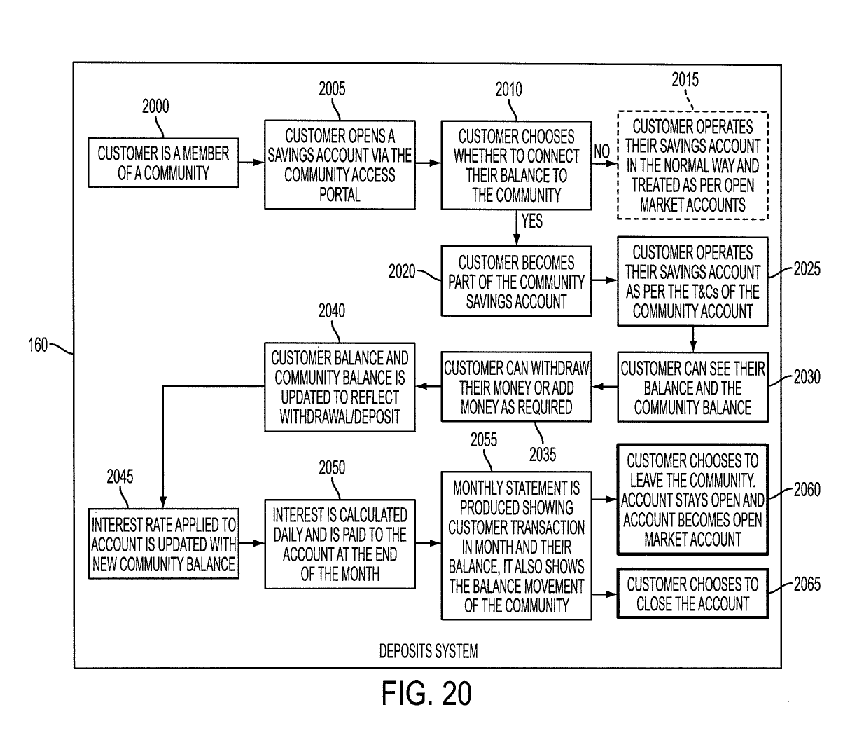

FIG. 20 illustrates an example of community deposits system components of online community 200. In the illustrated embodiment, deposits system 160 recognizes that the customer is in online community 200 connected to others (block 2000) and opens a savings account via a community access portal, such as a virtual storefront (block 2005). Deposits system 160 provides the customer with a choice of whether to connect or link the customer's balance to the community (block 2010). If the customer declines to connect the customer's balance to the community, the customer's savings account is treated as per open market accounts and the customer operates the customer's savings account in the normal way (block 2015).

If the customer agrees to connect the balance of the customer's deposit with the other members of the community, the customer becomes part of the community savings account (block 2020) and the customer's savings account is treated as per the terms and conditions of the community account (block 2025). In this situation, the customer can see the customer's balance and the community balance (block 2030), can withdraw the customer's money or add money as required (block 2035), such as via a linked checking account that was verified as part of the account opening process, and the customer balance and community balance is updated to reflect the withdrawal/deposit (block 2040). Thus, while the community can see the total balance of the community deposits, only the relevant customer can make a withdrawal or deposit to their own individual account.

The total community balance figure is used to calculate the interest paid on all community accounts, so the interest rate applied to the customer's account can be updated with the new community balance (block 2045). The product can be a savings product to allow simple calculation of interest and to avoid the complexity of people “tying” money up within online community 200. The interest rate can be calculated daily and the interest compounded daily, and the interest can be paid to the accounts monthly (block 2050) such as at the end of the month. Interest rates can go up or down depending on the community balance position.

Statements can be provided monthly and can include detail on the customer's account as well as the community balance position (block 2055). At no time can a customer see another community member's transactions or individual balances. Customers can remove themselves from online community 200, in which case the deposit account stays open and becomes an open market account, receiving the standard rate offered to individual customers (block 2060). Customers can also choose to close the account, removing their balance from the community balance (block 2065).

The system can further provide for sharing profit with the community upon achieving certain performance measures. In order to building loyalty within the consumer financial services product, incremental profits can be distributed in a way that the community chooses once internal financial hurdles are achieved. A system can be created to determine how much value each member of the community will receive or if the community will donate the money to a specific charity (e.g., chosen by the community).

The system can further provide for members to vote for certain features of the financial services product. Also to build loyalty within the consumer financial services product, certain features of the product can be evaluated by the community. A tradeoff analysis and summary can be provided to provide customers with sufficient transparency so community members can make a decision. A poll can be created where members of the community can vote on the features they would like included in the feature set within their community. For example, members can vote if they would like their customer service call center to be located in the USA or at an offshore location. The tradeoff could be more profit share for the community in exchange for lower perceived service quality. A vote can determine the outcome and the community can be notified of the preferred change and the date the product change will be implemented. Another exemplary vote can be how to share profits. As mentioned above, the community could vote to allocate shared profit to a charity and also decide which charity project receives the funds.

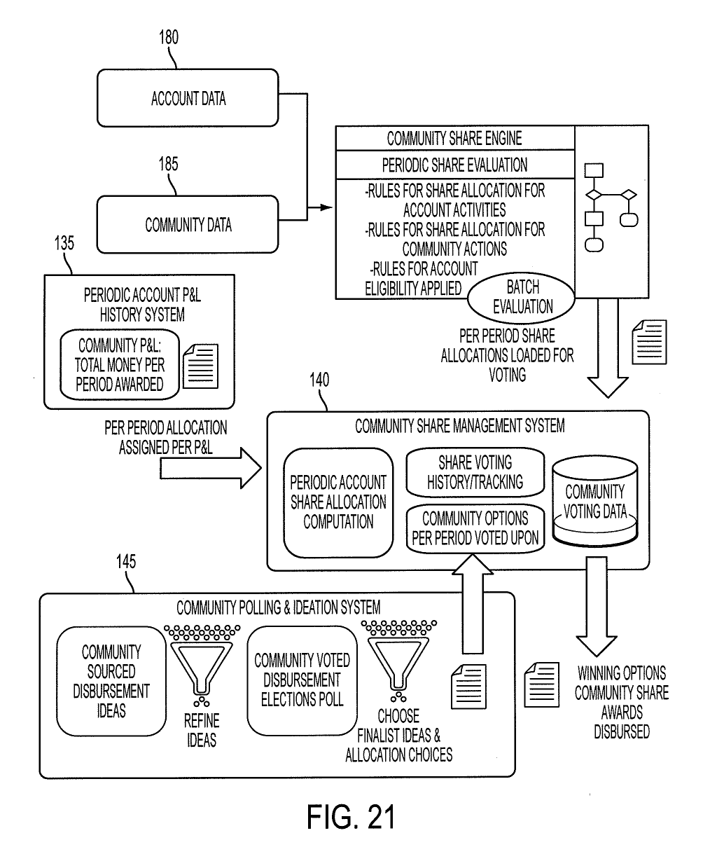

FIG. 21 illustrates an example of community share management system components of online community 200. As shown in FIG. 21, community share management system 140 can receive per period share allocations loaded for voting from a periodic share evaluation by a community share engine. In the periodic share evaluation, the per period share allocations can be evaluated in a batch evaluation, for example, based on account data 180 and community data 185 and applying rules for share allocation for account activities, rules for share allocation for community actions and rules for account eligibility.

Community share management system 140 can perform a periodic account share allocation computation with community voting data based on the per period share allocations loaded for voting, a received per period allocation assigned per P&L, such as the total money per period awarded based on the community P&L described above, and the allocation choices received from community polling & ideation system 145. Community polling & ideation system 145 can collect and refine community sourced disbursement ideas to be voted on, conduct community voted disbursement elections polls and provide the allocation choices resulting therefrom to community share management system 140. As a result of the periodic account share allocation computation, community share management system 140 can provide the winning options and disburse the community share awards. Community share management system 140 can also share voting history/tracking.

The system can provide multiple types of polls for voting, such as:

Market research and profiling: this can be information and data gathering on new product ideas or customer preferences. This will be a place where we can get quick feedback from customers across a wide array of ideas. Information can also be stored to help sub-segment customers for future development opportunities. This type of poll can happen often. These polls can be displayed for a short amount of time.

Product design: members can vote on changing product sets. This can include voting on fees (call center charges, over limit, late payment, cash advance), on shore vs. offshore servicing, 60+ day repricing, etc. These can be offered on a case by case basis within the community depending on the overall P&L of the community. Since these polls can happen infrequently, these polls can be posted for a longer time to allow a maximum number of members to see it and take action.

Profit Share decision: members can determine how community profits are to be divided up, whether for a charity cause or back to individuals for example. This could be on a periodic basis, such as quarterly.

The system can further provide automatically performing a recurring credit card balance transfer from one bank account to another, such as setting up an automatic sweep from one credit card account to another, at the customer's request. In order to avoid customers from having to re-submit bank information every time they want to transfer a balance between banks, the system can store credit card balance transfer information and allow customers to retrieve it easily upon logging into the servicing website for example. In addition, the system can allow the customer to set up a balance transfer in the future. If the amount of the transfer is unknown, the bank and customer can interact through any online channel and submit just the balance transfer dollar amount. The system can communicate to/notify the member if the requested balance transfer will fail (e.g., if the member has an insufficient credit line) and allow the member to cancel the request.

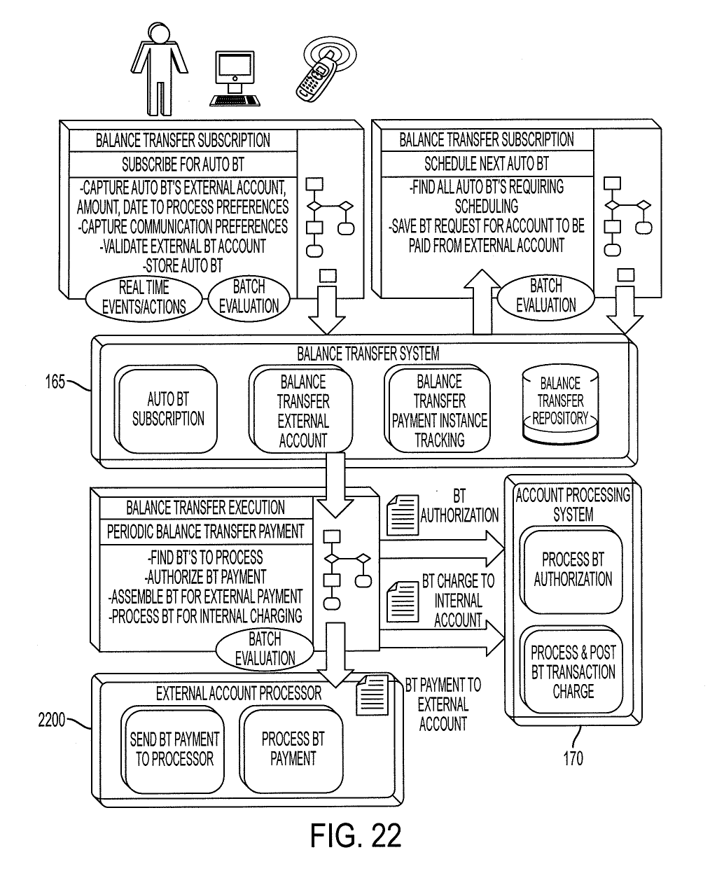

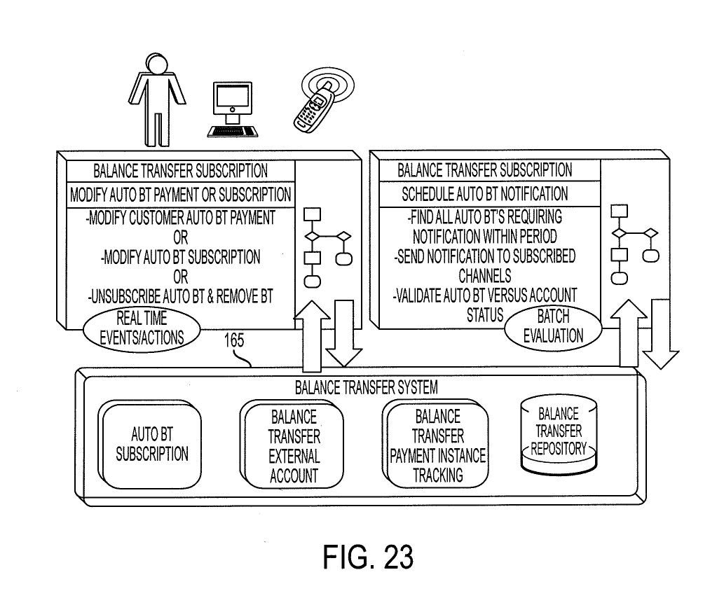

FIGS. 22-23 illustrate examples of recurring balance transfer system components of online community 200. As shown in FIGS. 22-23, balance transfer system 165 manages a balance transfer repository and provides auto balance transfer subscription, balance transfers to external accounts and balance transfer payment instance tracking. In particular, with respect to balance transfer subscription balance transfer system 165 can subscribe a customer for automatic balance transfer and schedule the next automatic balance transfer as shown in FIG. 22, and can modify automatic balance transfer payment or subscription and schedule automatic balance transfer notifications as shown in FIG. 23.

With respect to subscribing a customer for automatic balance transfer, balance transfer system 165 can capture the automatic balance transfer's external account, amount, and date to process preferences, capture communication preferences, validate the external balance transfer account and store the automatic balance transfer in the balance transfer repository. This can be applied based on real time events/actions and also in a batch evaluation.

With respect to scheduling the next automatic balance transfer, balance transfer system 165 can determine all automatic balance transfers requiring scheduling by searching the balance transfer repository and save the determined balance transfer requests for account to be paid from external account. This can be applied in a batch evaluation.

With respect to modifying automatic balance transfer payment or subscription, balance transfer system 165 can modify a customer automatic balance transfer payment, modify an automatic balance transfer subscription or unsubscribe the automatic balance transfer and remove the balance transfer in accordance with the customer's instructions. This can be applied based on real time events.

With respect to scheduling automatic balance transfer notifications, balance transfer system 165 can determine all automatic balance transfers requiring notification within a period by searching the balance transfer repository, send a notification to the corresponding customer via the subscribed channels, and validate the automatic balance transfer versus account status (e.g., determine if the member has an insufficient credit line to process the balance transfer). This can be applied in a batch evaluation.

With respect to balance execution, balance transfer system 165 can perform periodic balance transfer payment by determining balance transfers to process by searching the balance transfer repository, authorizing the balance transfer payments, assemble the balance transfers for external payment, and processing the balance transfers for internal charging. Balance transfer system 165 can provide the balance transfer authorization to account processing system 170 to process the balance transfer authorization, and can provide the balance transfer charge to internal account to account processing system 170 to process and post the balance transfer transaction charge. Balance transfer system 165 can provide the balance transfer payment to external account to external account processor 2200 to send the balance transfer payment to the processor and process the balance transfer payment.

The system can further provide for referral fees to be paid to the community. By law, application decision results are not allowed to be communicated to any individual other than the applicant, so paying a referral fee to a member upon approval is therefore disallowed. However, the system can allow an approved applicant brought in by referral to earn the entire community revenue in addition to profit sharing. The referral revenue can be divided among those members who referred completed applications or amongst the entire community (in some embodiments the community can choose which one). Thus, the individual referring the potential member is not notified about any individual application decision.

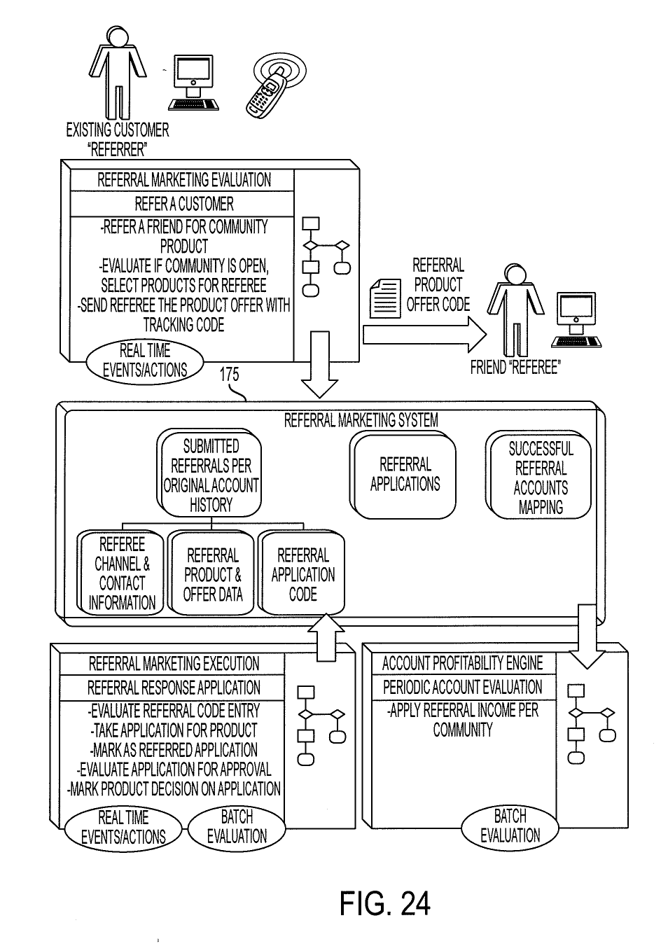

FIG. 24 illustrates an example of community referral marketing system components of online community 200. As shown in FIG. 24, referral marketing system 175 can comprise referral data 190 and perform referral marketing evaluation and referral marketing execution using referral data 190.

With respect to referral marketing evaluation, marketing system 175 can facilitate the referral of a customer (referee) by receiving a referral submitted by an existing customer (referrer) for a community product, evaluating if the community is open and selecting products for the referee if open, and sending the referee the product offer with a tracking code. This can be applied based on real time events/actions.

With respect to referral marketing execution, marketing system 175 can process a referral response application by evaluating a referral code entry received from the referee, taking an application for product from the referee, marking the application as a referred application in referral data 190, evaluating the application for approval and marking the product decision on the application in referral data 190. This can be applied based on real time events/actions and also in a batch evaluation.

An account profitability engine can use referral data 190 to perform a periodic account evaluation by applying referral income per community as described above. This can be applied based on a batch evaluation.

The system can further provide for the highest rated community members to participate in a financial services community panel to discuss product improvements. Since customers do not have sufficient engagement in product design, the system can invite certain community members (e.g., the most active members within a community) to join a panel that discusses next generation product constructs for a financial services product. The panel can be monitored by an employee of the financial institution with the purpose of engaging the panel in a feedback discussion to identify new features.

The system can further provide for recruiting members to a financial services community by targeting individuals using online influencing scores. The cost of acquiring customers can be high and customers appear to be increasingly listening to the opinions of people in online forums. Since an individual's ability to influence others can be scored and an individual's online activity on Facebook or Twitter, for example, can be monitored, the number of people the individual influences can be tracked and converted into a score. This system for recruitment can find individuals who have significant influence over potential members of a financial services community. The individuals with influence can be provided the product so as to experience it and report about it online. This in turn can influence others to sign up for community membership.

The system can further provide for building and managing online communities and the unique features of those products. Due to the cost to acquire customers and building loyalty within a consumer financial services product, the community product can have a set of features that are the same across communities (e.g. terms, rules of engagement, reputation management system), a set of features that are unique (e.g., community P&L, forums, polling results) and still others that the community can adjust (e.g., servicing options, fee levels, profit share distribution). The system can manage all of the features of these communities. In addition, communities can have a status placed on them describing their openness to new members. A community can be closed to new members, open only to membership by referral or open to all new members who apply. When a community is closed to new members or close to closing, the system can decide whether or not to build a copy of that community for future members. The system can also distribute approved members into the appropriate community.

The system can further provide for members to transfer to other online communities or for online communities to be combined. Members may find more interest in a new or different community and may wish to be transferred. In addition, appropriate scale may not be achieved forcing two or more different communities to be combined. Members can therefore choose to transfer to another community, provided that the community is open to new members. The system can transfer information on all of the unique elements of the online community product. If the two or more communities are too small to support servicing costs and are copies of the same community terms, the system can merge the two like communities into one community.

The system can further provide for customers to design future online financial services communities. Due to the cost to acquire customers and the need for customers to exhibit more control over their financial services product options, customers can request an online community to be developed. Once the customer has recruited a significant number of potential members within a specific timeframe, the community can be built and opened up for activity. The community can also be configured to design their own plastic card and determine which content it is providing to members.

The system can further provide for member's activity in the online community to be translated into a virtual currency that can be transferred into other currencies. Due to difficulty building loyalty within a consumer financial services product, member activity can earn a virtual currency. For example, posting a helpful article to the online forum could earn the member two “dollars.” These dollars could be given value in cash through the profit share pool, be translated into other virtual currencies, or be redeemed for a set cash value not related to profit share levels for example. The system could also integrate a financial services product where it has two credit lines—one for hard currency and one for virtual currency.

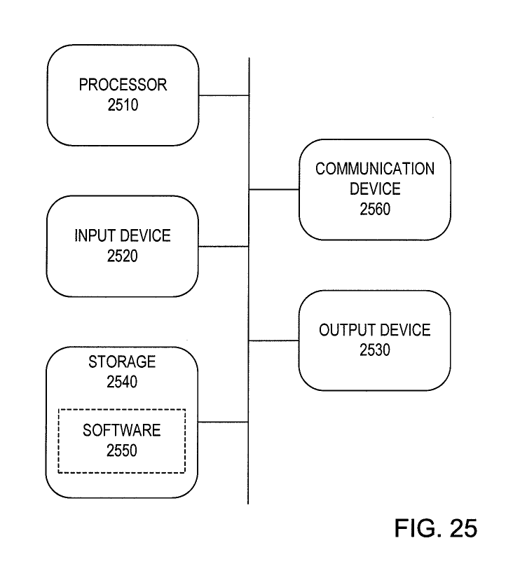

FIG. 25 shows a block diagram of an example of a computing device, which may generally correspond to server 100, member 110, member 115, member 120 and member 125. The form of computing device 2500 may be widely varied. For example, computing device 2500 can be a personal computer, workstation, server, handheld computing device, or any other suitable type of microprocessor-based device. Computing device 2500 can include, for example, one or more components including processor 2510, input device 2520, output device 2530, storage 2540, and communication device 2560. These components may be widely varied, and can be connected to each other in any suitable manner, such as via a physical bus, network line or wirelessly for example.

For example, input device 2520 may include a keyboard, mouse, touch screen or monitor, voice-recognition device, or any other suitable device that provides input. Output device 2530 may include, for example, a monitor, printer, disk drive, speakers, or any other suitable device that provides output.

Storage 2540 may include volatile and/or nonvolatile data storage, such as one or more electrical, magnetic or optical memories such as a RAM, cache, hard drive, CD-ROM drive, tape drive or removable storage disk for example. Communication device 2560 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 2550 can be stored in storage 2540 and executed by processor 2510, and may include, for example, programming that embodies the functionality described in the various embodiments of the present disclosure. The programming may take any suitable form. Software 2550 may include, for example, a combination of servers such as application servers and database servers.

Software 2550 can also be stored and/or transported within any computer-readable storage medium for use by or in connection with an instruction execution system, apparatus, or device, such as computing device 2500 for example, that can fetch instructions associated with the software from the instruction execution system, apparatus, or device and execute the instructions. In the context of this document, a computer-readable storage medium can be any medium, such as storage 2540 for example, that can contain or store programming for use by or in connection with an instruction execution system, apparatus, or device.

Software 2550 can also be propagated within any transport medium for use by or in connection with an instruction execution system, apparatus, or device, such as computing device 2500 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system comprising:
one or more servers configured to
provide an online community associated with a financial services product,
restrict membership of the online community to users of the financial services product, and
allow social interaction via the online community between any members of the membership.

2. The system of claim 1, wherein the financial services product comprises a credit card.

3. The system of claim 1, comprising one or more servers configured to
determine a status level for each member of the online community based on an amount of activity associated with the respective member, and
render in the online community a status indicator reflecting the determined status level for each member.

4. The system of claim 3, wherein the amount of activity associated with the respective member comprises an amount of financial account activity associated with the respective member.

5. The system of claim 3, wherein the amount of activity associated with the respective member comprises an amount of activity undertaken by the respective member in the online community.

6. The system of claim 3, wherein the status indicator comprises multiple segments, each of the segments corresponding to a distinct type of activity associated with the respective member.

7. The system of claim 6, wherein for one or more of the segments, a size of the respective segment changes based on an amount of the distinct type of activity corresponding to the respective segment that is associated with the respective member.

8. The system of claim 6, wherein the multiple segments form a partial or complete geometric shape.

9. The system of claim 1, comprising one or more servers configured to periodically publish in the online community a profit and loss statement associated with the financial services product.

10. The system of claim 9, wherein the profit and loss statement identifies one or more expenses variably based on behavior of the membership and identifies an extent to which the membership behavior can reduce the one or more expenses.

11. The system of claim 1, comprising one or more servers configured to
store data associated with an applicant whose application to join the online community has been declined,
determine, after a period of time has passed since the application was declined, whether a financial status of the applicant meets or exceeds a threshold, and
invite the applicant to join the online community if the financial status of the applicant is determined to meet or exceed the threshold.

12. The system of claim 1, comprising one or more servers configured to
connect a balance of a deposit account associated with a first member of the online community to a balance of a deposit account associated with one or more other members of the online community, and
use a total of the balances of the deposit accounts associated with the first member and the one or more other members to calculate an interest rate to apply to the deposit account associated with the first member.

13. The system of claim 1, comprising one or more servers configured to allow the membership to vote on features of the financial services product.

14. The system of claim 1, comprising one or more servers configured to set up in the online community an automatic transfer of a balance associated with the financial services product.

15. The system of claim 1, comprising one or more servers configured to distribute a share of profits associated with the financial services product to the membership based on performance of the membership with respect to the financial services product.

16. The system of claim 1, comprising one or more servers configured to
identify a portion of the membership based on activity undertaken in the online community, and
invite the portion of the membership to join a panel to discuss potential future financial services products.

17. The system of claim 1, comprising one or more servers configured to distribute referral revenue among multiple members of the membership based on approval of an applicant to join the online community who was referred by one of the multiple members.

18. The system of claim 1, comprising one or more servers configured to
identify an individual with an online activity score that meets or exceeds a threshold, and
invite the identified individual to join the online community if the online activity score is determined to meet or exceed the threshold.

19. The system of claim 1, comprising one or more servers configured to.
provide one or more additional online communities associated with distinct financial services products, and
provide a first set of features that are common to the online communities, a second set of features that are unique to each of the online communities, and a third set of features that membership of the respective online communities can adjust.

20. The system of claim 1, comprising one or more servers configured to.
provide one or more additional online communities associated with financial services products, and
transfer members between the online communities or combine the online communities.

21. The system of claim 1, comprising one or more servers configured to.
receive a request to develop an online community associated with a financial services product,
determine whether a number of potential members for the requested online community meet or exceed a threshold, and
provide the requested online community if the number of potential members is determined to meet or exceed the threshold.

22. The system of claim 1, comprising one or more servers configured to provide virtual currency to a member of the online community based on activity undertaken by the member in the online community.

23. A method comprising:
providing, by one or more servers executed by a processor, an online community associated with a financial services product;
restricting, by one or more servers executed by a processor, membership of the online community to users of the financial services product;
allowing, by one or more servers executed by a processor, social interaction via the online community between any members of the membership;
determining, by one or more servers executed by a processor, a status level for each member of the online community based on an amount of activity undertaken by the respective member in the online community;
rendering in the online community, by one or more servers executed by a processor, a status indicator reflecting the determined status level for each member;
periodically publishing, by one or more servers executed by a processor, in the online community a profit and loss statement associated with the financial services product;
storing, by one or more servers executed by a processor, data associated with an applicant whose application to join the online community has been declined;
determining, by one or more servers executed by a processor, after a period of time has passed since the application was declined, whether a financial status of the applicant meets or exceeds a threshold;
inviting, by one or more servers executed by a processor, the applicant to join the online community if the financial status of the applicant is determined to meet or exceed the threshold;
connecting, by one or more servers executed by a processor, a balance of a deposit account associated with a first member of the online community to a balance of a deposit account associated with one or more other members of the online community;
using, by one or more servers executed by a processor, a total of the balances of the deposit accounts associated with the first member and the one or more other members to calculate an interest rate to apply to the deposit account associated with the first member;
allowing, by one or more servers executed by a processor, the membership to vote on features of the financial services product; and
setting up in the online community, by one or more servers executed by a processor, an automatic transfer of a balance associated with the financial services product.
